(19) United States
(12) Patent Application Publication
(10) Pub. No.: US 2007/0014365 A1
(43) Pub. Date: Jan. 18, 2007

(54) Method and system for motion estimation

(76) Inventor: Alexander MacInnis, Ann Arbor, MI (US)

Correspondence Address: MCANDREWS HELD & MALLOY, LTD, 500 WEST MADISON STREET, SUITE 3400, CHICAGO, IL, 60661, US

(21) Appl. No.: 11/485,666

(22) Filed: Jul. 13, 2006

Related U.S. Application Data
(60) Provisional application No. 60/701,182, filed on Jul. 18, 2005.
(60) Provisional application No. 60/701,177, filed on Jul. 18, 2005.
(60) Provisional application No. 60/701,178, filed on Jul. 18, 2005.
(60) Provisional application No. 60/701,180, filed on Jul. 18, 2005.
(60) Provisional application No. 60/701,181, filed on Jul. 18, 2005.
(60) Provisional application No. 60/701,179, filed on Jul. 18, 2005.

(51) Int. Cl. H04N 11/02; H04N 11/04; H04B 1/66

(52) U.S. Cl. 375/240.16; 375/240.24; 375/240.29

(57) ABSTRACT

Described herein is a method and system for estimating motion in a video sequence. When motion is present in the video sequence, this system and method may require the identification of motion data that include reference blocks and motion vectors. The motion data may be utilized by a motion compensated temporal filter (MCTF) for the reduction of noise. A video encoder may also utilize the motion data for encoding and removing temporal redundancy.

### RELATED APPLICATIONS

This application claims priority to “METHOD AND SYSTEM FOR MOTION ESTIMATION“, Provisional Application for U.S. Patent Ser. No. 60/701,182, filed Jul. 18, 2005, by MacInnis, which is incorporated by reference herein for all purposes.

This application is related to the following applications, each of which is hereby incorporated herein by reference in its entirety for all purposes:

U.S. Provisional Patent Application Ser. No. 60/701,179, METHOD AND SYSTEM FOR NOISE REDUCTION WITH A MOTION COMPENSATED TEMPORAL FILTER, filed Jul. 18, 2005 by MacInnis;

U.S. Provisional Patent Application Ser. No. 60/701,181, METHOD AND SYSTEM FOR MOTION COMPENSATION, filed Jul. 18, 2005 by MacInnis;

U.S. Provisional Patent Application Ser. No. 60/701,180, METHOD AND SYSTEM FOR VIDEO EVALUATION IN THE PRESENCE OF CROSS-CHROMA INTERFERENCE, filed Jul. 18, 2005 by MacInnis;

U.S. Provisional Patent Application Ser. No. 60/701,178, METHOD AND SYSTEM FOR ADAPTIVE FILM GRAIN NOISE PROCESSING, filed Jul. 18, 2005 by MacInnis; and

U.S. Provisional Patent Application Ser. No. 60/701,177, METHOD AND SYSTEM FOR ESTIMATING NOISE IN VIDEO DATA, filed Jul. 18, 2005 by MacInnis.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video communications systems are continually being enhanced to meet requirements such as reduced cost, reduced size, improved quality of service, and increased data rate. Many advanced processing techniques can be specified in a video compression standard. Typically, the design of a compliant video encoder is not specified in the standard. Optimization of the communication system's requirements is dependent on the design of the video encoder.

Video encoding standards, such as H.264, may utilize a combination of intra-coding and inter-coding. Intra-coding uses information that is contained in the picture itself. Inter-coding uses prediction from other pictures via e.g. motion estimation and motion compensation. The encoding process for motion compensation typically consists of selecting motion data that describes a displacement applied to samples of another picture. As the number of ways to partition and predict a picture increases, this selection process can become very complex, and optimization can be difficult given the constraints of some hardware.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for motion estimation, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a block diagram of an exemplary motion compensated temporal filter in accordance with an embodiment of the present invention;

FIG. 2 is a block diagram describing inter prediction in accordance with an embodiment of the present invention;

FIG. 3 is a flow diagram of an exemplary method for motion estimation in accordance with an embodiment of the present invention;

FIG. 4 is a block diagram of an exemplary video encoding system in accordance with an embodiment of the present invention;

FIG. 5A is a picture of an exemplary communication device in accordance with an embodiment of the present invention; and

FIG. 5B is a picture of an exemplary video display device in accordance with an embodiment of the present invention.

### DETAILED DESCRIPTION OF THE INVENTION

According to certain aspects of the present invention, a system and method for the estimation of motion in a video sequence are presented. When motion is present in the video sequence, this system and method may require the identification of motion data that include reference blocks and motion vectors. The motion data may be utilized by a motion compensated temporal filter (MCTF) for the reduction of noise and a video encoder for removing temporal redundancy.

A processor may receive a video sequence that contains noise. When the video sequence includes a static section, a temporal noise filter can be applied to that section to reduce the noise. When objects in the section begin to move, a subtle edge of a moving object can cause motion trails when filtered. To avoid creating motion trails or other video artifacts, the noise filter may be turned off or its effect reduced at the onset of detected movement. When the noise is no longer filtered, it appears to a viewer that the noise level increases. Also, suddenly turning the noise filter on and off may create additional video artifacts. For example, a picture may contain a person's face, and while the person is still, the picture may appear very clear. When the person begins talking, the face may move slightly, and along the edge of the face, noise may appear.

Since the noise in the video sequence with motion cannot be temporally filtered directly without causing motion trails, motion compensation applied within the filter can reduce the generation of motion trails while allowing noise reduction.

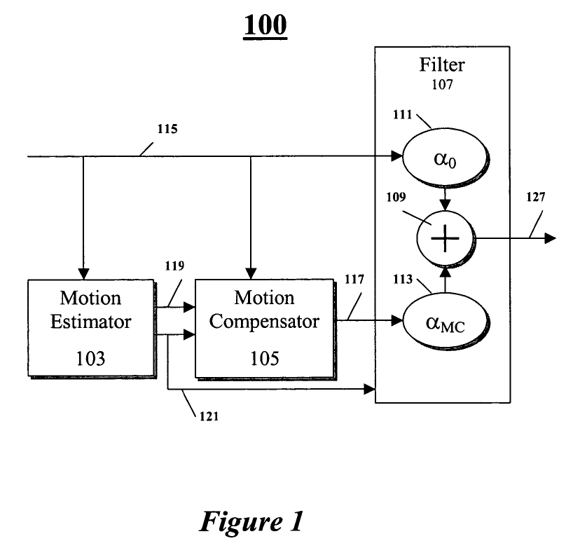

Referring now to FIG. 1, a block diagram of an exemplary Motion Compensated Temporal Filter (MCTF) 100 is illustrated in accordance with an embodiment of the present invention. The MCTF 100 comprises a motion estimator 103, a motion compensator 105, and a filter 107.

A Motion Compensated Temporal Filter (MCTF) can apply motion compensation prior to filtering in the time domain. The motion estimator 103 may generate motion vectors 119 with associated quality metrics 121. The motion vectors 119 may indicate the space and time displacement between a current video block and a candidate reference block. The quality metrics 121 may indicate a cost for or confidence in using a particular motion vector 119.

The motion compensator 105 may rank the motion vectors 119 according to the quality metrics 121. According to the ranking, one or more reference blocks are selected. If two or more reference blocks are selected, the reference blocks may be combined through weighted averaging.

The selected reference block or combination of reference blocks 117 and the current video block 115 are sent to the filter 107. Within the filter 107, the reference block or combination of reference blocks 117 is scaled by a value α_{MC} 113. The current block 115 is scaled by a value α₀. The filter 107 may adapt α₀ 115 and α_{MC} 117 according to the quality metrics 121. The sum of α_{MC} 113 and α₀ 111 may be maintained at a value of approximately one. The scaled blocks are combined at 109 to generate a current output block 127. Since the reference block(s) may contain correlated content and uncorrelated noise, the ratio of content to noise could increase when reference block(s) are combined with the current video block.

Motion Compensated Temporal Filter system(s), method(s), and apparatus are described in METHOD AND SYSTEM FOR NOISE REDUCTION WITH A MOTION COMPENSATED TEMPORAL FILTER, Attorney Docket No. 16839US01, filed Jul. 18, 2005 by MacInnis, and incorporated herein by reference for all purposes.

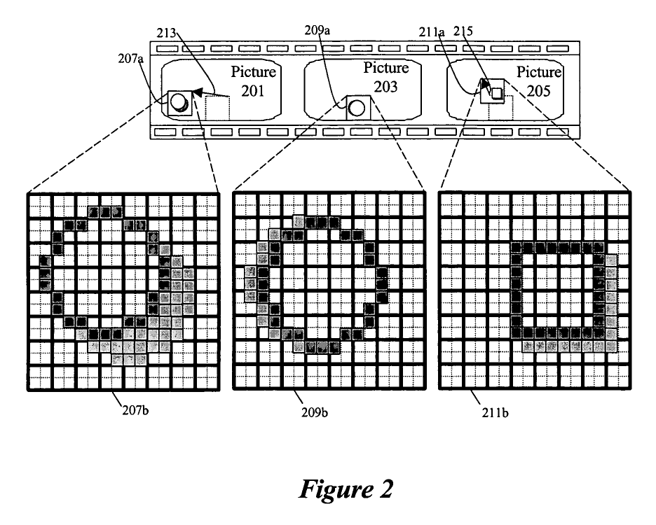

In FIG. 2, there is illustrated a video sequence comprising pictures 201, 203, and 205 that can be used to describe motion estimation. Motion estimation may utilize a previous picture 201 and/or a future picture 205. A reference block 207 in the previous picture 201 and/or a reference block 211 in the future picture 205 may contain content that is similar to a current block 209 in a current picture 203. Motion vectors 213 and 215 give the relative displacement from the current block 209 to the reference blocks 207 and 211 respectively.

With reference to a motion vector, a block is a set of pixels to which the motion vector applies. A 16×16 block corresponds to a motion vector per macroblock. A 16×16 block may be more likely than a smaller block to cause false motion artifacts when objects having different motion velocities are spatially close together. The smallest size a block can be is 1×1, i.e. one pixel.

Since the sampling density of a block may not be the same in both the vertical axis and the horizontal axis, the dimensions of a block can be different. In a 4×3 interlaced picture with 720 pixels horizontally and 240 pixels vertically, the horizontal sampling density is approximately 2.25 times the vertical sampling density. A 2×1 or 3×1 block would appear approximately square when displayed.

FIG. 2 also illustrates an example of a scene change. In the first two pictures 201 and 203 a circle is displayed. In the third picture 205 a square is displayed. There will be a high confidence that the past reference block 207 can predict the current block 209, and there will be a low confidence that the future reference block 211 can predict the current block 209.

Confidence and other quality metrics utilized in certain embodiments of the present invention can be generated by the system(s), method(s), or apparatus described in METHOD AND SYSTEM FOR MOTION COMPENSATION, Attorney Docket No. 16840US01, filed Jul. 18, 2005 by MacInnis, and incorporated herein by reference for all purposes.

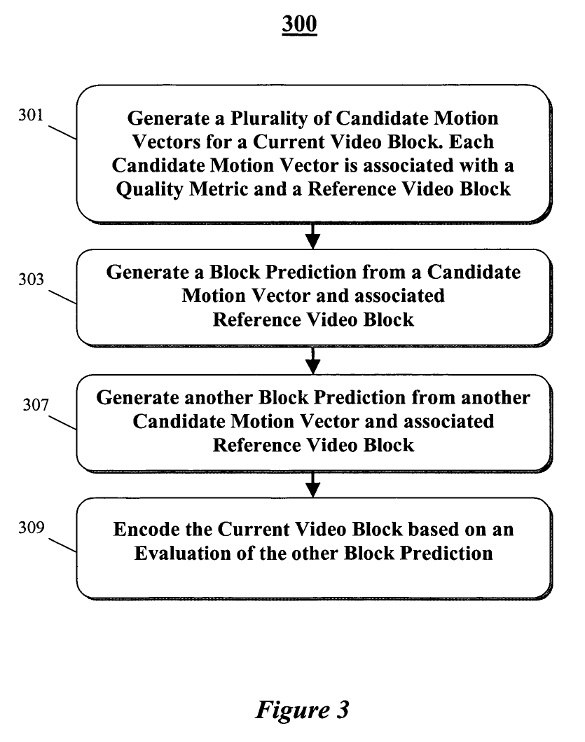

FIG. 3 is a flow diagram, 300, of an exemplary method for motion estimation in accordance with an embodiment of the present invention.

At 301, a plurality of candidate motion vectors is generated for a current video block. The motion estimator 103 of FIG. 1 may generate each candidate motion vector with an associated quality metric.

At 303, a block prediction is generated from a candidate motion vector and an associated reference video block. The motion compensator 105 of FIG. 1 may apply the candidate motion vector to the reference video block according to the associated quality metric. The motion compensated block predicts the current video block. Motion is compensated for in the current video block by utilizing the block prediction.

A filter may be used to reduce noise while compensatinge for motion. A variety of filter types are possible, such as FIR, IIR, or combined FIR/IIR of any order. For example, a first-order IIR filter may combine a weighted sum of the current video block and the block prediction. The filter 107 in FIG. 1 may generate the weighted sum, and the weighting of the current video block and the block prediction may be adjusted based on the quality metric associated with the candidate motion vector.

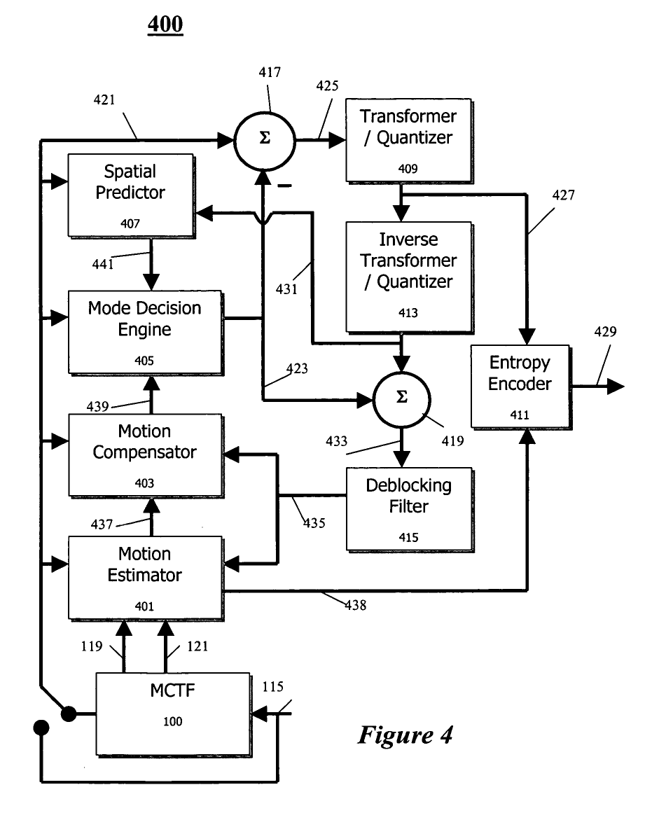

At 307, another block prediction is generated from another candidate motion vector and associated reference video block. The motion estimator 401 of FIG. 4 may generate the other candidate motion vector, and the motion compensator 403 of FIG. 4 may apply the other candidate motion vector to the associated reference video block. Associated reference video blocks in 303 and 307 may be the same block or two different blocks.

At 309, the current video block is encoded based on an evaluation of the other block prediction. Encoding may occur after compensating for motion, and therefore, the motion compensated block may be encoded. For example, MCTF 100 provides an input to the rest of the system 400 in FIG. 4. Such an arrangement may allow the reduction of noise in a preprocessing module before the noise is embedded in the video coding.

Referring now to FIG. 4, there is illustrated a block diagram of an exemplary system 400 using motion estimation. The video encoder 400 comprises a motion estimator 401, a motion compensator 403, a mode decision engine 405, spatial predictor 407, a transformer/quantizer 409, an entropy encoder 411, an inverse transformer/quantizer 413, and a deblocking filter 415.

Spatially predicted pictures are intra-coded. The spatial predictor 407 uses only the contents of a current picture 421 for prediction. The spatial predictor 407 receives the current picture 421 and inverse transformed, inverse quantized picture elements 431 from the current picture and produces a spatial prediction 441 corresponding to the current block 209 as described in reference to FIG. 2. The current picture 421 may be the output 127 or input 115 of the MCTF 100.

In the motion estimator 401, a partition macroblock in the current picture 421 is the prediction from reference pixels 435 using a set of motion vectors 437. Partition is defined, for example, in the AVC H.264/MPEG-4 Part 10 standard. The motion estimator 401 may receive the partition macroblock in the current picture 421 and a set of reference pixels 435 for prediction. The motion estimator 401 may also receive a macroblock in the current picture and create partitions. The motion estimator 401 may evaluate candidate motion vectors and select one or more of them. The motion estimator 401 may also evaluate various partitions of the macroblock and candidate motion vectors for the partitions. The motion estimator 401 may output motion vectors, associated quality metrics, and optional partitioning information.

The motion compensator 403 receives the motion vectors 437 and the partition macroblock in the current picture 421 and generates a temporal prediction 439. The motion vectors 119 and associated quality metrics 121 of the MCTF 100 may be utilized to improve the decisions made by the motion estimator 401.

The mode decision engine 405 will receive the spatial prediction 441 and temporal prediction 439 and quality metrics associated with both and may select the prediction mode according to the quality metrics, e.g. a sum of absolute transformed difference (SATD) cost that optimizes rate and distortion. A selected prediction 423 is output.

Once the mode is selected, a corresponding prediction error 425 is the difference 417 between the current picture 421 and the selected prediction 423. The transformer/quantizer 409 transforms the prediction error and produces quantized transform coefficients 427.

The entropy encoder 411 may receive the quantized transform coefficients 427 and other information, including motion vectors, partitioning information, and spatial prediction modes and produce a video output 429. In the case of temporal prediction, a set of picture reference indices, motion vectors, and partitioning information are entropy encoded as well.

The quantized transform coefficients 427 are also fed into an inverse transformer/quantizer 413 to produce a regenerated prediction error 431. The original prediction 423 and the regenerated prediction error 431 are summed 419 to regenerate a reference picture 433 that is passed through the deblocking filter 415 and used for motion estimation. The regenerated reverence picture 433 is also passed to the spatial predictor 407 where it is used for spatial prediction.

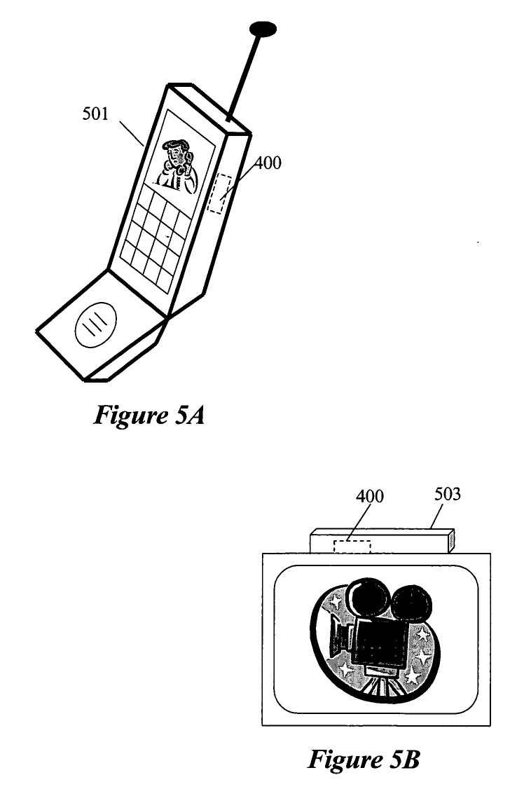

FIG. 5A is a picture of an exemplary communication device in accordance with an embodiment of the present invention. A mobile telephone 501 equipped with video capture and/or display may comprise the system 400 with motion estimation.

FIG. 5B is a picture of an exemplary video display device in accordance with an embodiment of the present invention. A set-top box 502 equipped with video capture and/or display may comprise the system 400 with motion estimation.

The embodiments described herein may be implemented as a board level product, as a single chip, application specific integrated circuit (ASIC), or with varying levels of a video processing circuit integrated with other portions of the system as separate components. An integrated circuit may store a supplemental unit in memory and use an arithmetic logic to encode, detect, filter, and format the video output.

The degree of integration of the video processing circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, the invention can be applied to video data encoded with a wide variety of standards.

Therefore, it is intended that the present invention not be limited to the particular embodiment disclosed, but that the present invention will include all embodiments falling within the scope of the appended claims.

1. A method for motion estimation, said method comprising:
filtering a video sequence with a motion compensated temporal filter, wherein the motion compensated temporal filter generates a motion vector associated with a first video block of a first size; and
utilizing the motion vector to encode a second video block of a second size.

2. The method for motion estimation in claim 1, wherein the first size is smaller than the second size.

3. The method of claim 1, wherein the motion vector is selected according to a quality metric generated by the motion compensated temporal filter.

4. The method of claim 1, wherein one or more pixels in the first video block are also in the second video block.

5. A system for motion estimation, said system comprising:
a motion compensated temporal filter comprising:
a first motion estimator for selecting a first motion vector from a plurality of candidate motion vectors associated with a current input block;
a first motion compensator for applying the first motion vector to a first reference block, thereby generating a first motion compensated block; and
a filter for reducing noise in the current input block based on the motion compensated block; and
a video encoder comprising a second motion estimator for selecting a second motion vector from the plurality of candidate motion vectors.

6. The system of claim 5, wherein the first motion vector is selected based on a ranking of an associated quality metric.

7. The system of claim 5, wherein the filter reduces noise by selectively combining the current video block and the first block prediction.

8. The system of claim 5, wherein the first candidate motion vector is selected according to a quality metric generated by the motion compensated temporal filter.

9. The system of claim 5, wherein the video encoder receives the filter output.

10. The system of claim 5, wherein the quality metric associated with the second candidate motion vector is adjusted according to the filter output.

11. An integrated circuit comprising:
a memory for storing a video sequence;
a filter for reducing noise in the video sequence based on motion prediction; and
an encoder for encoding the video sequence according to the motion prediction used in the filter.
